(19) United States
(12) Patent Application Publication
(10) Pub. No.: US 2018/0364616 A1
(43) Pub. Date: Dec. 20, 2018

(54) ROTATABLE-MEMBER-SUPPORTING STRUCTURE, TRANSPORT DEVICE, CHARGING DEVICE, AND IMAGE FORMING APPARATUS

(71) Applicant: FUJI XEROX CO., LTD., Tokyo (JP)

(72) Inventors: Atsushi FUNADA, Kanagawa (JP); Masataka KONISHI, Kanagawa (JP); Tsuyoshi SUNOHARA, Kanagawa (JP); Yasunori FUJIMOTO, Kanagawa (JP); Takahito CHIBA, Kanagawa (JP); Takashi ANZAI, Kanagawa (JP)

(73) Assignee: FUJI XEROX CO., LTD., Tokyo (JP)

(21) Appl. No.: 15/947,871

(22) Filed: Apr. 9, 2018

(30) Foreign Application Priority Data
Jun. 19, 2017 (JP) 2017-119235

(51) Int. Cl. G03G 15/00

(52) U.S. Cl. CPC G03G 15/0818; G03G 15/6529; G03G 15/2089; G03G 15/0233

(57) ABSTRACT

A rotatable-member-supporting structure includes a first rotatable member having a shaft portion, a bearing member by which the shaft portion of the first rotatable member is rotatably supported, a pressing member that presses the bearing member in one direction, and a supporting member by which the bearing member is supported in such a manner as to be retractably movable in the direction in which the pressing member presses the bearing member. A pressing force generated by the pressing member is greatest in a portion of the bearing member that is on a downstream side in a direction of rotation of the first rotatable member with respect to an intersection between the bearing member and a first virtual line extending from a center of rotation of the first rotatable member toward the pressing member in the direction in which the supporting member is retractably movable.

### CROSS-REFERENCE TO RELATED APPLICATIONS

This application is based on and claims priority under 35 USC 119 from Japanese Patent Application No. 2017-119235 filed Jun. 19, 2017.

### BACKGROUND

### Technical Field

The present invention relates to a rotatable-member-supporting structure, a transport device, a charging device, and an image forming apparatus.

### SUMMARY

According to an aspect of the invention, there is provided a rotatable-member-supporting structure including a first rotatable member having a shaft portion, a bearing member by which the shaft portion of the first rotatable member is rotatably supported, a pressing member that presses the bearing member in one direction, and a supporting member by which the bearing member is supported in such a manner as to be retractably movable in the direction in which the pressing member presses the bearing member. A pressing force generated by the pressing member is greatest in a portion of the bearing member that is on a downstream side in a direction of rotation of the first rotatable member with respect to an intersection between the bearing member and a first virtual line extending from a center of rotation of the first rotatable member toward the pressing member in the direction in which the supporting member is retractably movable.

### BRIEF DESCRIPTION OF THE DRAWINGS

Exemplary embodiments of the present invention will be described in detail based on the following figures, wherein:

FIG. 1 illustrates an outline configuration of an image forming apparatus according to first and other exemplary embodiments;

FIG. 2 is an enlargement of a part (a discharge transport path near a fixing device) of the image forming apparatus illustrated in FIG. 1;

FIG. 3 is a partially sectional diagram illustrating a pair of discharge rollers (including supporting structures) provided over the discharge transport path illustrated in FIG. 2;

FIG. 4A illustrates an outline of one of the supporting structures that supports a follower roller included in the pair of discharge rollers illustrated in FIG. 3;

FIG. 4B is a sectional diagram taken along line IVB-IVB illustrated in FIG. 4A:

FIG. 5 illustrates an outline configuration and so forth of the pair of discharge rollers illustrated in FIG. 3 that serves as a decurling mechanism;

FIG. 6 illustrates the supporting structure according to the first exemplary embodiment that supports the follower roller;

FIG. 7A illustrates the supporting structure illustrated in FIGS. 6A and 6B that is in a state where a pressing force is generated;

FIG. 7B illustrates the supporting structure illustrated in FIG. 7A that is in a state where the follower roller is rotated;

FIG. 8 illustrates an exemplary modification of the supporting structure according to the first exemplary embodiment;

FIG. 9A illustrates a configuration of a supporting structure according to a second exemplary embodiment that supports the follower roller and that is in a state where a pressing force is generated;

FIG. 9B illustrates the supporting structure illustrated in FIG. 9A that is in a state where the follower roller is rotated;

FIG. 10A illustrates a configuration of a supporting structure according to a third exemplary embodiment that supports the follower roller and that is in a state where a pressing force is generated;

FIG. 10B illustrates the supporting structure illustrated in FIG. 10A that is in a state where the follower roller is rotated;

FIG. 11 illustrates an exemplary modification of a bearing member (only the outer shape of a relevant part is illustrated) included in the supporting structure according to the second exemplary embodiment;

FIG. 12 illustrates an exemplary modification of the supporting structure according to the third exemplary embodiment;

FIG. 13 illustrates a supporting structure according to a fourth exemplary embodiment that supports a charging roller, and a charging device including the same;

FIG. 14A illustrates the supporting structure illustrated in FIG. 13 that is in a state where a pressing force is generated;

FIG. 14B illustrates the supporting structure illustrated in FIG. 14A that is in a state where the charging roller is rotated;

FIG. 15 illustrates an outline configuration of a comparative supporting structure that supports a rotatable member such as a follower roller;

FIG. 16A illustrates the supporting structure illustrated in FIG. 15 that is in a state where a pressing force is generated; and

FIG. 16B illustrates the supporting structure illustrated in FIG. 16A that is in a state where the rotatable member is rotated.

### DETAILED DESCRIPTION

### First Exemplary Embodiment

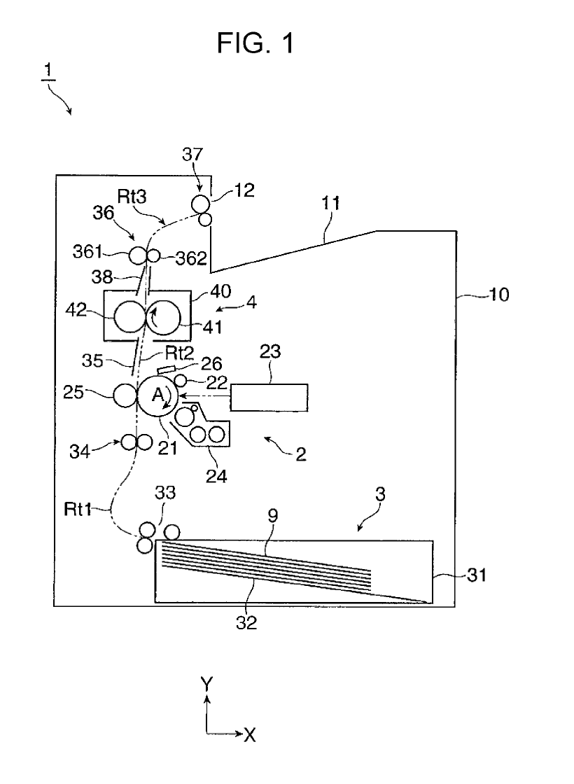

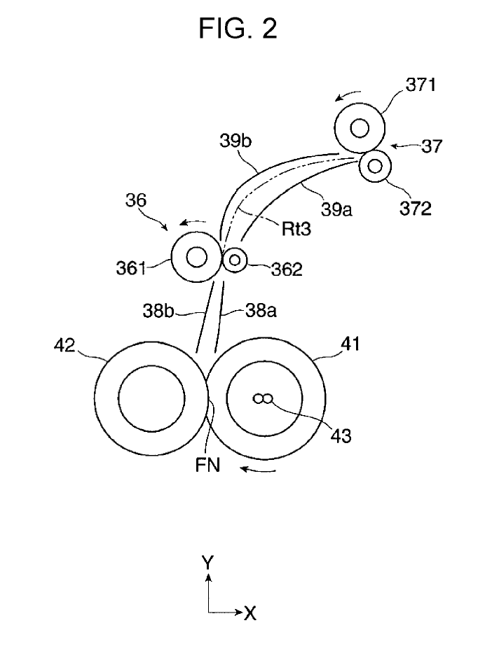

FIGS. 1 and 2 illustrate a first exemplary embodiment of the present invention. FIG. 1 illustrates a configuration of an image forming apparatus 1 according to the first exemplary embodiment. FIG. 2 is an enlargement of a discharge transport path provided in the image forming apparatus 1 illustrated in FIG. 1.

### Overall Configuration of Image Forming Apparatus

The image forming apparatus 1 forms an image composed of developer (toner) on a recording sheet 9, which is an exemplary transport object or an exemplary recording material, in accordance with information on the image, which includes any of characters, photographs, figures, and so forth.

Referring to FIG. 1, the image forming apparatus 1 has a housing 10 as a body thereof and includes thereinside an imaging device 2 that forms a toner image from the toner as the developer by an electrophotographic method or the like and transfers the toner image to a recording sheet 9, a sheet feeding device 3 that contains required recording sheets 9 and feeds the recording sheets 9 one by one to a transfer position defined in the imaging device 2, a fixing device 4 that fixes the toner image transferred to the recording sheet 9, and so forth.

The housing 10 is formed of structural members, exterior materials, and other miscellaneous members. The housing 10 has an output receiving portion 11 at the top thereof. The output receiving portion 11 receives the recording sheet 9 having an image and discharged thereto. The output receiving portion 11 has a receiving surface that is a tilted surface provided below a discharge port 12 provided in the housing 10. The output receiving portion 11 receives the recording sheet 9 that is discharged from the discharge port 12.

The imaging device 2 includes a photoconductor drum 21 that is rotatable in the direction of arrow A, and devices such as a charging device 22, an exposure device 23, a developing device 24, a transfer device 25, and a cleaning device 26 that are arranged in that order around the photoconductor drum 21.

The charging device 22 employs a contact-charging method or the like and charges the peripheral surface (the outer peripheral surface serving as an image forming area) of the photoconductor drum 21 to a required polarity and a required potential. The exposure device 23 exposes the charged peripheral surface of the photoconductor drum 21 to light (represented by a two-dot-chain-line arrow) emitted therefrom in accordance with image information (a signal) inputted to the image forming apparatus 1 by a relevant method, thereby forming an electrostatic latent image on the photoconductor drum 21. The developing device 24 supplies charged toner as the developer to the photoconductor drum 21, thereby developing the electrostatic latent image on the photoconductor drum 21 into a toner image. The transfer device 25 employs a contact-transfer method and electrostatically transfers the toner image on the photoconductor drum 21 to a recording sheet 9. The cleaning device 26 cleans the photoconductor drum 21 by removing unnecessary substances such as residual toner from the peripheral surface of the photoconductor drum 21.

The sheet feeding device 3 includes a sheet container 31 that contains plural recording sheets 9 that are stacked on a stacking plate 32 and are of a size, type, or the like required for intended image formation, a feeding unit 33 that feeds the recording sheets 9 one by one from the sheet container 31, and other miscellaneous members.

The sheet container 31 is attached to the housing 10 in such a manner as to be drawable therefrom. Depending on the mode of use, plural sheet containers 31 may be provided. The recording sheet 9 may be a recording medium such as plain paper, coated paper, cardboard, or the like that is cut into pieces of a predetermined size.

The fixing device 4 has a housing 40 having an inlet and an outlet and includes thereinside a heating-purpose rotatable member 41, a pressing-purpose rotatable member 42, and so forth. The heating-purpose rotatable member 41 and the pressing-purpose rotatable member 42 are rotatable while being in contact with each other.

As illustrated in FIGS. 1, 2, and others, the heating-purpose rotatable member 41 is rotatable in the direction of the arrow illustrated in FIG. 1 and serves as a heating-purpose fixing member provided in the form of a roller, a belt, or the like. The heating-purpose rotatable member 41 is heated by a heating device 43 such that the peripheral-surface temperature thereof is kept at a required temperature. The pressing-purpose rotatable member 42 serves as a pressing-purpose fixing member extending substantially in the axial direction of the heating-purpose rotatable member 41 and provided in the form of a roller, a belt, or the like that rotates by being in contact with the heating-purpose rotatable member 41 with a required pressure. In the fixing device 4, the nip between the heating-purpose rotatable member 41 and the pressing-purpose rotatable member 42 is defined as a fixing part FN through which the recording sheet 9 having an unfixed toner image is made to pass for a required fixing process (heating, pressurization, and so forth).

### Configuration of Transport Path

In the image forming apparatus 1, as represented by a two-dot chain line in FIG. 1, a transport path Rt along which the recording sheet 9 is transported is defined in the housing 10. The transport path Rt includes a feeding transport path Rt1, a relay transport path Rt2, a discharge transport path Rt3, and so forth.

As illustrated in FIG. 1, the feeding transport path Rt1 connects the feeding unit 33 of the sheet feeding device 3 and the transfer position (the position where the photoconductor drum 21 and the transfer device 25 face each other) defined in the imaging device 2 to each other. The feeding transport path Rt1 is provided with a pair of transport rollers 34 and plural transport-guide members (not illustrated).

The pair of transport rollers 34 serves as a pair of registration rollers having a function of correcting the skew of the recording sheet 9 by transporting the recording sheet 9 without rotating, and a function of feeding the recording sheet 9 to the transfer position by rotating in accordance with the timing of the above transfer process.

As illustrated in FIG. 1, the relay transport path Rt2 connects the transfer position defined in the imaging device 2 and the fixing part FN defined in the fixing device 4. The relay transport path Rt2 is provided with a required transport-guide member 35.

As illustrated in FIGS. 1, 2, and others, the discharge transport path Rt3 connects the fixing part FN defined in the fixing device 4 and the discharge port 12. The discharge transport path Rt3 is provided with a pair of first discharge rollers 36, a pair of second discharge rollers 37, plural discharge-guide members 38 and 39, and so forth.

The pair of first discharge rollers 36 is provided near the outlet of the housing 40 of the fixing device 4 and includes a driving roller 361 that is driven to rotate and a follower roller 362 that rotates by being pressed against the driving roller 361. The pair of second discharge rollers 37 is provided at the discharge port 12 and includes a driving roller 371 that is driven to rotate and a follower roller 372 that rotates by being in contact with the driving roller 371. A structure for supporting the pair of first discharge rollers 36 and other relevant elements will be described separately below.

The discharge-guide member 38 includes a pair of members 38a and 38b arranged face to face with a transport space defined therebetween. The recording sheet 9 having undergone fixing is guided toward the pair of first discharge rollers 36 through the transport space. The discharge-guide member 39 includes a pair of members 39a and 39b arranged face to face with a transport space defined therebetween. The recording sheet 9 discharged from the pair of first discharge rollers 36 is guided toward the pair of second discharge rollers 37 through the transport space.

### Image Forming Operation Performed by Image Forming Apparatus

The image forming apparatus 1 performs an image forming operation described below. Herein, an image forming operation in which an image is formed on one side of the recording sheet 9 will be described.

First, a controller (not illustrated) provided in the image forming apparatus 1 receives a command for an image forming operation and activates relevant devices such as the imaging device 2 and the fixing device 4.

Accordingly, in the imaging device 2, the photoconductor drum 21 starts to rotate, the charging device 22 charges the peripheral surface of the photoconductor drum 21 to a predetermined polarity and a predetermined potential (in the first exemplary embodiment, the negative polarity), and the exposure device 23 applies light to the charged peripheral surface of the photoconductor drum 21 in accordance with image information, whereby an electrostatic latent image of a required pattern is formed on the photoconductor drum 21. Then, the developing device 24 supplies toner as the developer charged to a required polarity (in the first exemplary embodiment, the negative polarity) to the electrostatic latent image formed on the peripheral surface of the photoconductor drum 21, thereby developing the electrostatic latent image into a toner image.

Subsequently, the photoconductor drum 21 further rotates and transports the toner image to the transfer position where the photoconductor drum 21 faces the transfer device 25. Meanwhile, the sheet feeding device 3 is activated in accordance with the timing of transfer, and the feeding unit 33 feeds a recording sheet 9 into the feeding transport path Rt1 up to the transfer position in the imaging device 2. At the transfer position in the imaging device 2, the transfer device 25 electrostatically transfers the toner image on the photoconductor drum 21 to one side of the recording sheet 9 transported by the pair of registration rollers 34 provided in the feeding transport path Rt1. Furthermore, the cleaning device 26 cleans relevant parts, such as the peripheral surface of the photoconductor drum 21 having undergone transfer, for the next imaging process.

Subsequently, in the imaging device 2, the rotating photoconductor drum 21 sends the recording sheet 9 having the toner image transferred thereto into the relay transport path Rt2 and transports the recording sheet 9 toward the fixing device 4. In the fixing device 4, the recording sheet 9 is introduced into and made to pass through the fixing part FN between the heating-purpose rotatable member 41 and the pressing-purpose rotatable member 42 that are rotating. When the recording sheet 9 passes through the fixing part FN, the toner forming the toner image on the one side of the recording sheet 9 is melted with heat and is pressurized, whereby the toner image is fixed on the recording sheet 9.

Lastly, the recording sheet 9 having undergone fixing is transported along the discharge transport path Rt3 and is discharged onto the output receiving portion 11.

When the recording sheet 9 having undergone fixing is sent from the fixing part FN in the fixing device 4, the recording sheet 9 is guided by the discharge-guide member 38 provided on the upstream side of the discharge transport path Rt3 and is transported to the pair of first discharge rollers 36 that is rotating. Then, the recording sheet 9 is nipped by the pair of first discharge rollers 36 and receives a transport force, thereby being guided to the discharge-guide member 39 provided on the downstream side of the discharge transport path Rt3 and being transported to the pair of second discharge rollers 37 that is rotating. Then, the recording sheet 9 is nipped by the pair of second discharge rollers 37 and receives a transport force, thereby being discharged from the discharge port 12 of the housing 10 and is received by the output receiving portion 11.

Thus, a monochrome image composed of toner having one color is formed on one side of a recording sheet 9, and the image forming operation on the one side is finished. If a command for executing an image forming operation on plural recording sheets 9 is issued, the above process is repeated for the required number of times.

### Structure of Supporting Pair of First Discharge Rollers and Transport Device Including the Same

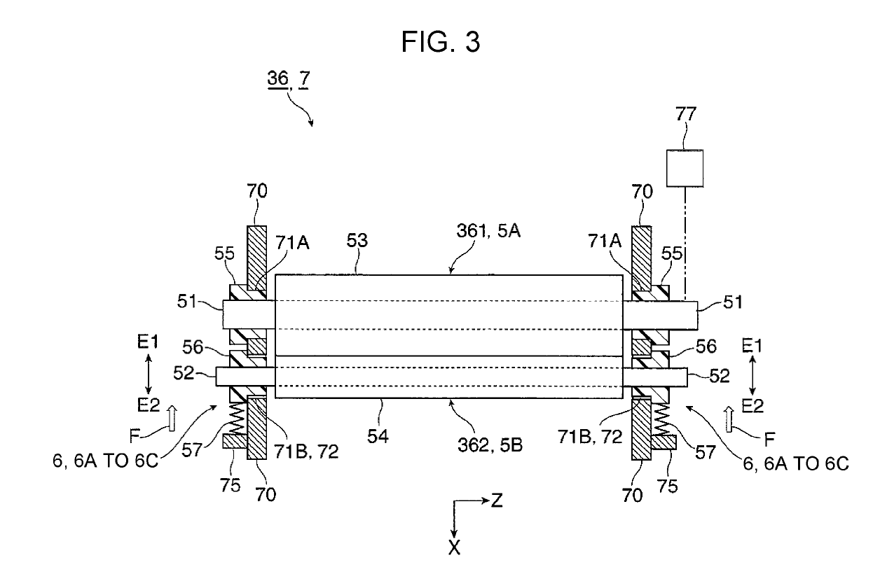

The image forming apparatus 1 employs a structure illustrated in FIGS. 3 to 6 and others for supporting the pair of first discharge rollers 36 provided in the discharge transport path Rt3.

As illustrated in FIG. 3 and others, the pair of first discharge rollers 36 includes, as elements of the driving roller 361 and the follower roller 362 thereof, rotatable members 5A and 5B including respective rotating shafts 51 and 52 and respective roller portions 53 and 54 provided around the outer peripheral surfaces of the respective rotating shafts 51 and 52. The rotating shafts 51 and 52 are rotatably supported by predetermined supporting members 70 with bearing members 55 and 56 interposed therebetween and such that the roller portions 53 and 54 are rotatable while being in contact with each other. The supporting members 70 are fixed at respective predetermined positions.

As illustrated in FIG. 3 and others, the pair of first discharge rollers 36 is configured such that the driving roller 361 is rotated in a required direction by receiving a required rotational power transmitted from a driving device 77. The driving roller 361 and the follower roller 362 in combination serve as a transport device 7 that transports the recording sheet 9, as an exemplary transport object, nipped between the driving roller 361 and the follower roller 362. The rotational power is transmitted from the driving device 77 to the driving roller 361 via a rotation transmitting mechanism (not illustrated) including a train of gears and so forth.

The rotating shaft 51 of the driving roller 361 as the rotatable member 5A is rotatably supported by the bearing members 55, and the bearing members 55 are each fixedly attached to a fixed attaching portion 71A included in a corresponding one of the supporting members 70. The fixed attaching portion 71A has a hole or a depression into which a portion of a corresponding one of the bearing members 55 is fitted, and includes other elements for fixing other portions of the bearing member 55.

That is, the driving roller 361 is rotatably supported by the supporting members 70 but the position thereof is fixed.

On the other hand, referring to FIGS. 3 to 5 and others, the rotating shaft 52 of the follower roller 362 as the rotatable member 5B is rotatably supported by the bearing members 56, and the bearing members 56 are each attached to a movable attaching portion 71B included in a corresponding one of the supporting members 70. Hence, the bearing member 56 is movable toward and away from the driving roller 361 by a predetermined length as represented by arrows E1 and E2. The movable attaching portion 71B has an oblong hole or a depression into which a portion of the bearing member 56 is movably fitted, and a holding portion and so forth by which other portions of the bearing member 56 are movably held.

The follower roller 362 is supported such that the bearing members 56 supporting the rotating shaft 52 thereof are pressed in the direction E1 toward the driving roller 361 by respective pressing members 57 provided on the respective movable attaching portions 71B.

As described above, the follower roller 362 is rotatably supported by (the attaching portions 71B of) the supporting members 70 while being allowed to move toward and away from the driving roller 361, and is also supported in such a manner as to be pressed in the direction E1 toward the driving roller 361 by the pressing members 57 with the bearing members 56 interposed therebetween.

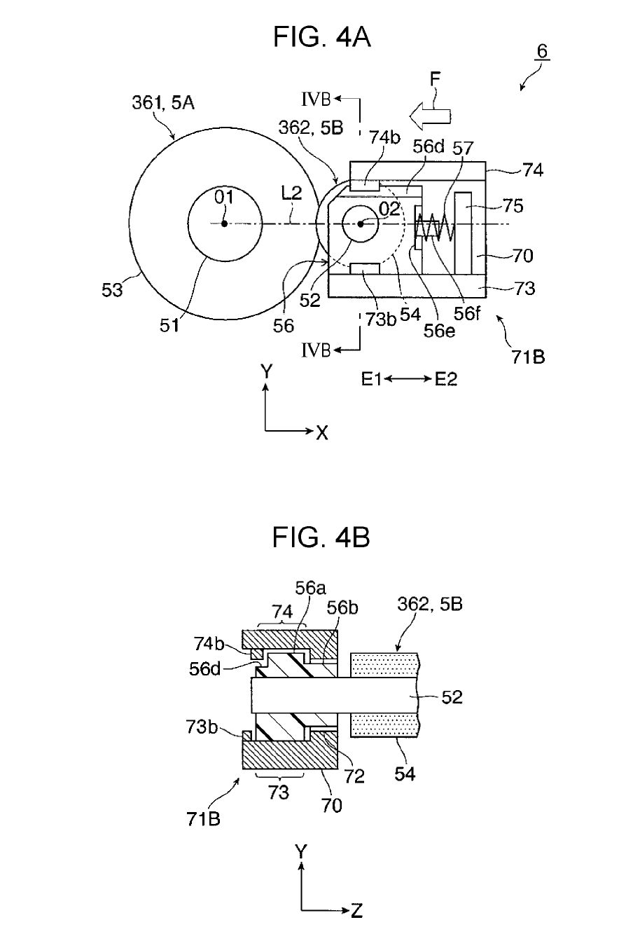

Referring to FIGS. 4A and 4B, each bearing member 56 includes a body 56a having a substantially rectangular side face, and a projection 56b projecting inward from the body 56a. The bearing member 56 has a shaft hole provided substantially in the center of the inner side face of the projection 56b and extending through the body 56a and the projection 56b, a stepped portion 56d provided at the upper edge of the outer side face of the body 56a and extending substantially horizontally, and so forth.

The attaching portion 71B of the supporting member 70 to which the bearing member 56 is attached in such a manner as to be movable back and forth in the directions E1 and E2 includes an oblong holding hole 72 in which the projection 56b of the bearing member 56 is held in such a manner as to be movable back and forth in the directions E1 and E2, a lower holding portion 73 by which the lower part of the body 56a of the bearing member 56 is held in such a manner as to be movable back and forth in the directions E1 and E2, and an upper holding portion 74 by which the upper part of the body 56a of the bearing member 56 is held in such a manner as to be movable back and forth in the directions E1 and E2.

The lower holding portion 73 includes a lower outer guide part 73b projecting upward. The lower outer guide part 73b guides the lower outer face of the body 56a of the bearing member 56 from the outer side when the bearing member 56 moves as described above. The upper holding portion 74 includes an upper outer guide part 74b projecting downward. The upper outer guide part 74b guides the stepped portion 56d at the outer upper edge of the body 56a of the bearing member 56 from the outer side when the bearing member 56 moves as described above.

The pressing member 57 only needs to be capable of elastically pressing the bearing member 56 in the direction E1 toward the driving roller 361 and may be, for example, a compression coil spring.

The pressing member 57 in the form of a compression coil spring has one end thereof attached to an attaching surface 56e of the bearing member 56. The attaching surface 56e is on a side of the body 56a that is opposite the driving roller 361. The other end, which is a free end, of the pressing member 57 is pressed against a receiving portion 75 projecting from the supporting member 70, whereby the entirety of the pressing member 57 is compressed in such a manner as to generate a required pressing force F. Referring to FIG. 4A, the bearing member 56 further includes a retaining projection 56f provided on the attaching surface 56e and fitted into a space inside the compression coil spring from the one end of the compression coil spring. The retaining projection 56f retains the one end of the compression coil spring so as to prevent the displacement of the one end.

As illustrated in FIGS. 3, 4A, and 4B, the follower roller 362 (the rotatable member 5B) included in the pair of first discharge rollers 36 is used with the driving roller 361 (the rotatable member 5A) that rotates while being in contact with the follower roller 362. The follower roller 362 is supported by a supporting structure 6 including the bearing member 56 by which the rotating shaft 52 as a shaft portion of the follower roller 362 is rotatably supported, the pressing member 57 that presses the bearing member 56 in the direction E1 toward the driving roller 361, and (the attaching portion 71B of) the supporting member 70 by which the bearing member 56 is supported in such a manner as to be movable back and forth in the direction E1 in which the pressing member 57 presses the bearing member 56.

If the driving roller 361 (the rotatable member 5A) is ignored, the supporting structure 6 may also be regarded as a supporting structure including the bearing member 56 by which the rotating shaft 52 of the follower roller 362 (the rotatable member 5B) is rotatably supported, the pressing member 57 that presses the bearing member 56 in one direction E1, and (the attaching portion 71B of) the supporting member 70 by which the bearing member 56 is supported in such a manner as to be movable back and forth in the direction E1 in which the pressing member 57 presses the bearing member 56.

The roller portion 53 of the driving roller 361 has a single-layer or multi-layer structure. At least one of the layers of the roller portion 53 may be an elastic layer. The roller portion 53 of the driving roller 361 according to the first exemplary embodiment includes an elastic layer made of silicone rubber or the like.

The roller portion 54 of the follower roller 362 also has a single-layer or multi-layer structure. The roller portion 54 of the follower roller 362 according to the first exemplary embodiment includes one layer that is made of fluororesin or the like.

The pair of first discharge rollers 36 according to the first exemplary embodiment serves as the transport device 7 as described above and also serves as a decurling mechanism that straightens the recording sheet 9 that is curled by passing through the fixing device 4.

In this respect, the driving roller 361 as one of the pair of first discharge rollers 36 is provided as an elastic roller member that is elastically deformable, and the follower roller 362 as the other of the two is provided as a hard roller member that is physically harder than the driving roller 361.

Specifically, the driving roller 361 is a roller member including the roller portion 53 thereof having a multi-layer structure including the above elastic layer. The follower roller 362 as a hard roller member has a single-layer structure including the roller portion 54 thereof made of fluororesin or the like, as described above.

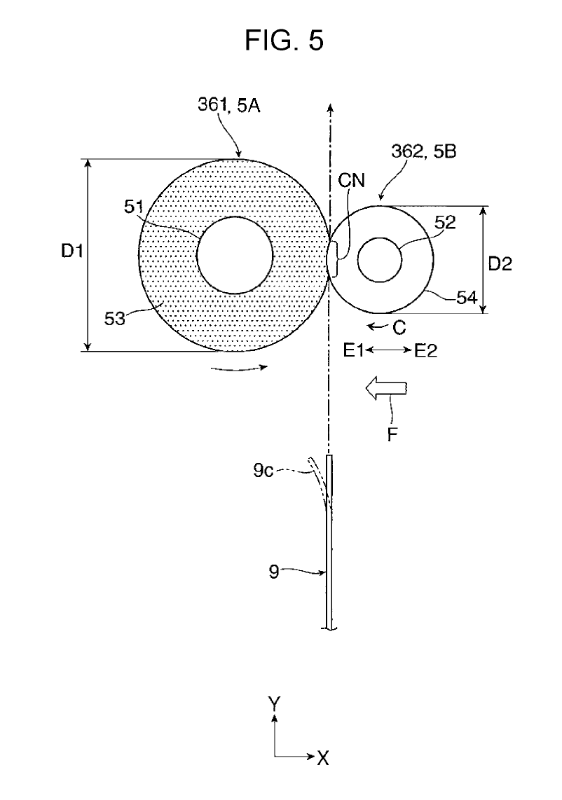

Referring to FIG. 5, the pair of first discharge rollers 36 is configured such that the roller portion 54 of the follower roller 362 has a diameter D2 that is smaller than a diameter D1 of the roller portion 53 of the driving roller 361.

In such a case, as illustrated in FIG. 2 and others, the driving roller 361 as an elastic roller member is provided on the same side as the pressing-purpose rotatable member 42 of the fixing device 4 with respect to the recording sheet 9 that is transported, and the follower roller 362 as a hard roller member is provided on the same side as the heating-purpose rotatable member 41 of the fixing device 4 with respect to the recording sheet 9 that is transported.

As illustrated in FIG. 5, in the pair of first discharge rollers 36 also serving as a decurling mechanism, a part of the roller portion 54, having the smaller diameter D2, of the follower roller 362 that is pressed with the pressing force F into the driving roller 361 bites a part of the roller portion 53, having the larger diameter D1, of the driving roller 361 supported at a fixed position. That is, the part of the roller portion 53 is elastically deformed into a curved shape conforming to the outer peripheral surface of the follower roller 362. In the pair of first discharge rollers 36, the part of the roller portion 53 that is elastically deformed while being in contact with the roller portion 54 serves as a decurling part CN.

Hence, even if the recording sheet 9 that has received the pressure from the pressing-purpose rotatable member 42 when passing through the fixing part FN of the fixing device 4 is deformed in such a manner as to curl toward the pressing-purpose rotatable member 42 (even if the recording sheet 9 comes to have a curled part 9c represented by a two-dot chain line in FIG. 5), the curled part 9c of the recording sheet 9 is straightened when the recording sheet 9 passes through the nip between the pair of first discharge rollers 36 provided in the discharge transport path Rt3.

That is, when the recording sheet 9 having curled toward the pressing-purpose rotatable member 42 passes through the decurling part CN in which the driving roller 361 is elastically deformed by being pressed by the follower roller 362, the recording sheet 9 is temporarily curled toward a side opposite the side toward which the curled part 9c has been curled. Consequently, the curled part 9c of the recording sheet 9 is straightened to be flat.

### Defects in Structure of Supporting Pair of First Discharge Rollers

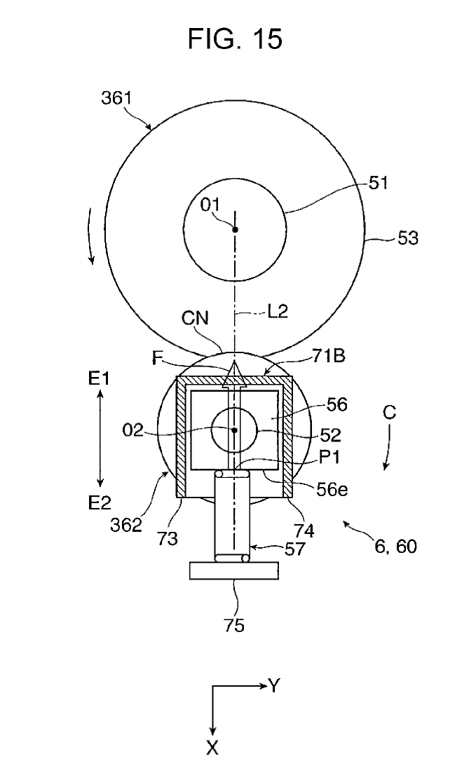

In general, referring to FIG. 15, the supporting structure 6 that supports the follower roller 362 included in the pair of first discharge rollers 36 is configured such that the pressing force F generated by the pressing member 57 is centered on an intersection P1 between the bearing member 56 and a virtual line L2 connecting a rotation center 02 of the follower roller 362 and a rotation center 01 of the driving roller 361 to each other. The supporting structure 6 configured as above is denoted as a comparative supporting structure 60.

In the supporting structure 60 configured as above, the compression coil spring as the pressing member 57 is positioned such that a center 57a of one end face thereof substantially coincides with the intersection P1 between the attaching surface 56e of the bearing member 56 and the virtual line L2. Note that the two end faces of the compression coil spring extend parallel to each other and each have a substantially flat annular shape, unless otherwise specified.

In the supporting structure 60 that supports the follower roller 362 illustrated in FIG. 15 and others, when the driving roller 361 is driven to rotate, the follower roller 362 rotates in the direction of arrow C by following the rotation of the driving roller 361.

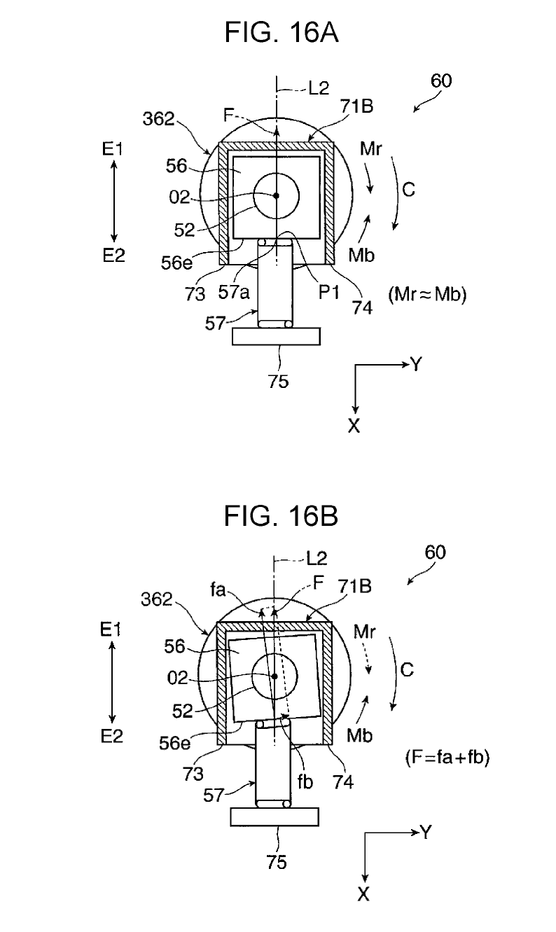

In this case, referring to FIG. 16A, the bearing member 56 receives a rotational force (moment) Mr generated by a frictional force between the bearing member 56 and the rotating shaft 52 of the follower roller 362 and that tends to rotate the bearing member 56 in the rotating direction C, and a rotational drag (moment) Mb generated by the pressing by the pressing member 57 in the form of the compression coil spring and that tends to stop the rotation of the bearing member 56.

In normal times, the rotational force Mr and the rotational drag Mb are substantially balanced with each other (Mr≈Mb). Therefore, as illustrated in FIG. 16A, the bearing member 56 is kept still without being rotated about the rotating shaft 52 inside (a movable space enclosed by) the movable attaching portion 71B of the supporting member 70.

However, since the frictional force or the like generated between the bearing member 56 and the rotating shaft 52 changes, a stick-slip phenomenon may occur. If a stick-slip phenomenon occurs in the supporting structure 60, the rotational force Mr changes.

For example, if the rotational force Mr becomes smaller than the rotational drag Mb (Mr<Mb), referring to FIG. 16B, the bearing member 56 rotates about the rotating shaft 52 in a direction opposite to the rotating direction C of the rotating shaft 52 (the follower roller 362) (a direction toward the upstream side in the rotating direction C) inside (the movable space enclosed by) the movable attaching portion 71B of the supporting member 70. In contrast, if the rotational force Mr becomes greater than the rotational drag Mb (Mr>Mb), the bearing member 56 that has rotated as described above returns to the initial normal position (illustrated in FIG. 16A) or further rotates in the rotating direction C (a direction toward the downstream side in the rotating direction C) of the rotating shaft 52 beyond the normal position.

That is, when the rotational force Mr changes, the bearing member 56 at its normal position rotates in the direction opposite to or the same as the rotating direction C of the rotating shaft 52 inside (the movable space enclosed by) the movable attaching portion 71B of the supporting member 70.

In particular, if the bearing member 56 rotates (is tilted) in the direction opposite to the rotating direction C of the rotating shaft 52, as illustrated in FIG. 16B, the pressing member 57 becomes in contact with the attaching surface 56e of the bearing member 56 that is tilted. Hence, the pressing force F generated by the pressing member 57 contains a component force fb acting in the direction opposite to the rotating direction C of the rotating shaft 52. With the generation of the component force fb, the rotational drag Mb tends to be kept large.

Consequently, in the supporting structure 60, if the bearing member 56 at the normal position rotates in the direction opposite to or the same as the rotating direction C of the rotating shaft 52 and then returns to the initial normal position from the rotated position or further rotates in the opposite direction beyond the rotated position repeatedly, noise or vibrations may occur. The occurrence of such noise or vibrations may hinder the pair of first discharge rollers 36 and the transport device 7 including the same from transporting the recording sheet 9 in a good manner without noise and vibrations.

The rotational force Mr and the stick-slip phenomenon tend to occur if the bearing member 56 is of a type that bears the rotating shaft 52 while allowing the sliding and rotation of the rotating shaft 52 thereon. Such a bearing of a sliding type is made of, for example, synthetic resin.

### Features of Supporting Structure for Supporting Pair of First Discharge Rollers and Effects Brought Thereby

As illustrated in FIGS. 4A, 6, and 7A, the supporting structure 6 for supporting the follower roller 362, which is one of the pair of first discharge rollers 36 according to the first exemplary embodiment, is configured such that the pressing force F generated by the pressing member 57 is greatest at a point of (the attaching surface 56e of) the bearing member 56 that is on the downstream side in the rotating direction C of the follower roller 362 with respect to the intersection P1 between the bearing member 56 and the virtual line L2 connecting the rotation center 02 of the follower roller 362 and the rotation center 01 of the driving roller 361.

The supporting structure 6 is not configured such that the pressing force F generated by the pressing member 57 is greatest at a point of the attaching surface 56e of the bearing member 56 that is on the upstream side in the rotating direction C of the follower roller 362 with respect to the intersection P1, so that a satisfactory force of pressing the follower roller 362 against the driving roller 361 is to be provided.

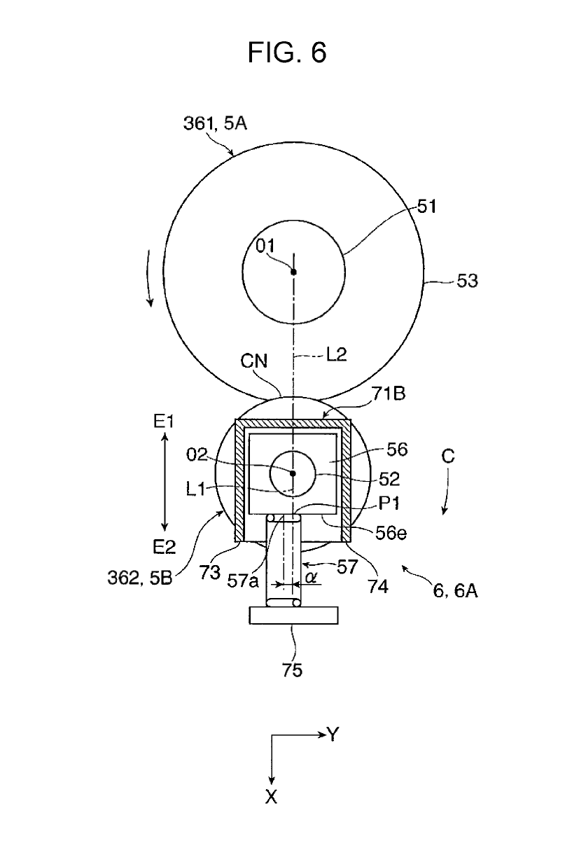

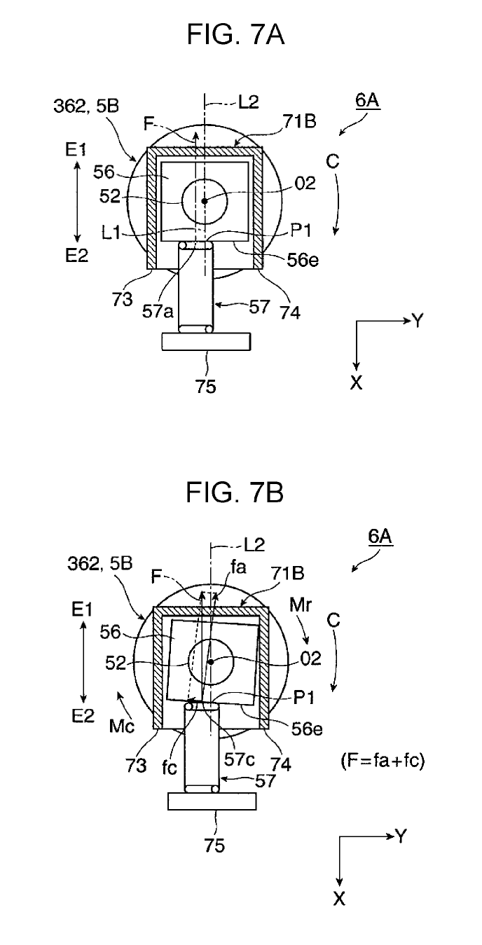

More specifically, as illustrated in FIGS. 6 and 7A, in the supporting structure 6 configured as described above, the compression coil spring as the pressing member 57 is positioned such that the center 57a of one end face (an end face having a substantially flat annular shape) thereof is displaced toward the downstream side in the rotating direction C of the follower roller 362 by a predetermined length (a displacement) a from the intersection P1 between the attaching surface 56e of the bearing member 56 and the virtual line L2.

Hereinafter, the supporting structure 6 configured as above is denoted as a supporting structure 6A and is distinguished from other supporting structures.

Referring to FIG. 7A, for example, if the driving roller 361 (the rotatable member 5A) illustrated in FIG. 2 and others is ignored, the supporting structure 6A may also be regarded as a supporting structure configured such that the pressing force F generated by the pressing member 57 is greatest at a point of (the attaching surface 56e of) the bearing member 56 that is on the downstream side in the rotating direction C of the follower roller 362 with respect to the intersection P1 between the bearing member 56 and a virtual line L1 extending from the rotation center 02 of the follower roller 362 toward the pressing member 57 in the directions E1 and E2 in which the attaching portion 71B of the supporting member 70 is movable back and forth. Such a concept of the supporting structure 6A is limited to a case where the virtual line L1 and the virtual line L2 coincide with each other as one continuous line.

More specifically, the supporting structure 6A illustrated in FIGS. 6 and 7A employs a configuration in which the compression coil spring as the pressing member 57 is positioned such that one end face thereof overlaps the intersection P1 between the attaching surface 56e of the bearing member 56 and the virtual line L2 while the center 57a of the one end face is displaced from the intersection P1.

In the supporting structure 6A illustrated in FIG. 7A that supports the follower roller 362, the pressing force F generated by the pressing member 57 is greatest at a point of the attaching surface 56e of the bearing member 56 that is on the downstream side in the rotating direction C of the follower roller 362 with respect to the intersection P1 between the attaching surface 56e and the virtual line L2 (or L1).

The end face of the pressing member 57 that is in contact with the attaching surface 56e of the bearing member 56 has a substantially flat annular shape. Therefore, the above pressing force F is centered on the center 57a of the end face of the pressing member 57.

In the supporting structure 6A, the pressing force F generated by the pressing member 57 is greatest at the point of the attaching surface 56e of the bearing member 56 that is displaced from the intersection P1. Therefore, regardless of whether or not the follower roller 362 is rotated, the bearing member 56 rotates about the rotating shaft 52, as illustrated in FIG. 7B, in the same direction as the rotating direction C of the rotating shaft 52 (the follower roller 362) inside (the movable space enclosed by) the movable attaching portion 71B of the supporting member 70. That is, the bearing member 56 as a whole is tilted. In this state, the end face of the compression coil spring as the pressing member 57 that is in contact with the attaching surface 56e of the bearing member 56 is tilted in such a manner as to follow the tilted attaching surface 56e of the tilted bearing member 56.

In the supporting structure 6A, when the follower roller 362 is rotating in the rotating direction C by following the rotation of the driving roller 361, as illustrated in FIG. 7B, not only the rotational force Mr generated by the frictional force between the bearing member 56 and the rotating shaft 52 of the follower roller 362 and that causes the bearing member 56 to rotate in the rotating direction C but also a second rotational force Mc described below is generated.

Specifically, in the supporting structure 6A, as illustrated in FIG. 7B, the pressing member 57 is in contact with the tilted attaching surface 56e of the bearing member 56. Therefore, the pressing force F generated by the pressing member 57 contains a component force fc acting in a direction similar to the rotating direction C of the rotating shaft 52, and the component force fc acts on the bearing member 56 as the second rotational force Mc that causes the bearing member 56 to rotate in the rotating direction C.

That is, in the supporting structure 6A, the bearing member 56 receives two rotational forces Mr and Mc. Therefore, the bearing member 56 is retained at a position determined after being rotated in the same direction as the rotating direction C of the rotating shaft 52 (the follower roller 362) inside (the movable space enclosed by) the movable attaching portion 71B of the supporting member 70. Hence, the bearing member 56 that has been rotated in the same direction as the rotating direction C tends to stand still at that position even if the stick-slip phenomenon occurs, and the bearing member 56 becomes less likely to rotate in the direction opposite to the rotating direction C.

Consequently, the supporting structure 6A does not make the repeated movement that tends to occur in the comparative supporting structure 60 (illustrated in FIGS. 15, 16A, and 16B) in which the bearing member 56 rotates in the direction opposite to or the same as the rotating direction C of the rotating shaft 52 and then returns to the initial normal position or further rotates beyond the normal position inside the movable space enclosed by the movable attaching portion 71B. Consequently, the occurrence of noise and vibrations attributed to the above repeated movement is suppressed.

Since the occurrence of noise and vibrations that may occur in the comparative supporting structure 60 is suppressed in the supporting structure 6A, the recording sheet 9 is transported in a good manner without the occurrence of noise and vibrations in the pair of first discharge rollers 36 and in the transport device 7 including the same.

If the pair of first discharge rollers 36 serving as the transport device 7 also has a function as a decurling mechanism as described above, not only the good transport of the recording sheet 9 without noise and vibrations but also the good decurling of the recording sheet 9 is realized.

In the supporting structure 6A, the above effects are produced even if the bearing member 56 is of a type that bears the rotating shaft 52 while allowing the sliding and rotation of the rotating shaft 52 thereon.

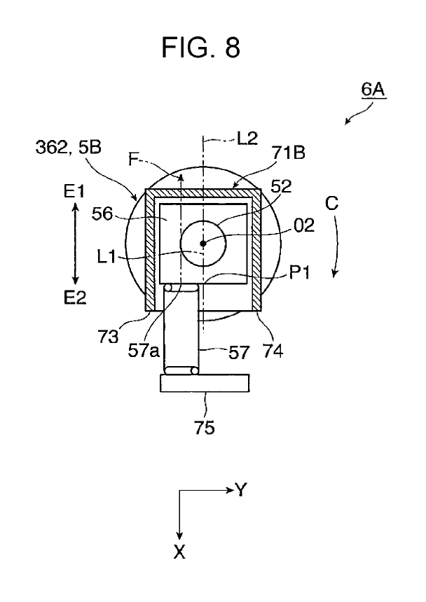

The supporting structure 6A according to the first exemplary embodiment only needs to be configured such that the pressing force F generated by the pressing member 57 is greatest at a point of the attaching surface 56e of the bearing member 56 that is on the downstream side in the rotating direction C of the follower roller 362 with respect to the intersection P1 between the attaching surface 56e and the virtual line L2 (or L1). Therefore, as illustrated in FIG. 8 for example, the compression coil spring as the pressing member 57 may be positioned such that the entirety of the one end face thereof that is in contact with the attaching surface 56e of the bearing member 56 does not overlap the intersection P1 between the attaching surface 56e and the virtual line L2 (or L1).

If the supporting structure 6A is configured as illustrated in FIG. 8, however, compared with the case of the supporting structure 6A (illustrated in FIGS. 6 and 7A) in which the compression coil spring as the pressing member 57 is positioned such that one end face thereof overlaps the intersection P1 on the attaching surface 56e of the bearing member 56 while the center 57a of the one end face is displaced from the intersection P1, the pressing force F generated by the pressing member 57 acts on a point of the attaching surface 56e of the bearing member 56 that is further away from the intersection P1 with the virtual line L2 (or L1), and the rate of a component of the pressing force F that presses the bearing member 56 and the driving roller 361 is reduced or dispersed. In this respect, the supporting structure 6A illustrated in FIG. 8 is inferior to the supporting structure 6A illustrated in FIGS. 6 and 7A.

Therefore, in the supporting structure 6A, the compression coil spring as the pressing member 57 is desirably positioned such that one end face thereof overlaps the intersection P1 between the attaching surface 56e of the bearing member 56 and the virtual line L2 while the center 57a of the one end face is displaced from the intersection P1.

### Second Exemplary Embodiment

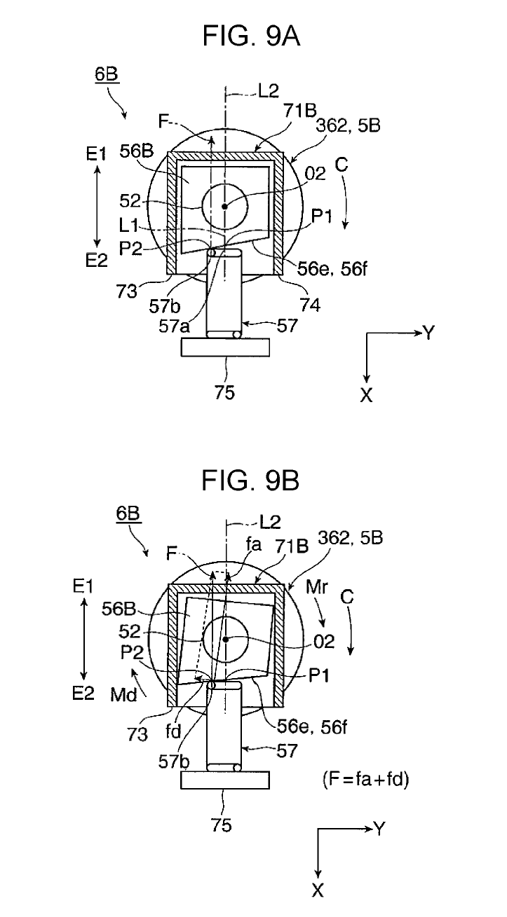

FIGS. 9A and 9B illustrate a supporting structure 6B according to a second exemplary embodiment that supports the follower roller 362.

The supporting structure 6B has the same configuration as the supporting structure 6A according to the first exemplary embodiment, except that the pressing force F generated by the pressing member starts to act on a point of the attaching surface 56e of the bearing member 56 that is on the downstream side in the rotating direction C of the follower roller 362 with respect to the intersection P1 between the attaching surface 56e and the virtual line L2 (or L1). Therefore, in FIGS. 9A and 9B, elements that are the same as those of the supporting structure 6A are denoted by corresponding ones of the reference numerals and characters used in the first exemplary embodiment.

As illustrated in FIG. 9A, the supporting structure 6B according to the second exemplary embodiment includes a bearing member 56B having an attaching surface 56f, instead of the bearing member 56 having the attaching surface 56e that is in contact with the pressing member 57. The attaching surface 56f is shaped in such a manner as to be first in contact with the pressing member 57 at a point P2 that is on the downstream side in the rotating direction C of the follower roller 362 with respect to the intersection P1 with the virtual line L2 (or L1). The bearing member 56B of the supporting structure 6B is positioned such that the intersection P1 on the attaching surface 56f thereof substantially coincides with the center 57a of the end face of the pressing member 57 that is in contact therewith.

As illustrated in FIG. 9A, the attaching surface 56f of the bearing member 56B according to the second exemplary embodiment is generally continuously tilted at a required angle such that a downstream portion thereof in the rotating direction C of the follower roller 362 is closer to the pressing member 57 than an upstream portion thereof.

The tilted attaching surface 56f is obtained by tilting the attaching surface 56e of the bearing member 56 according to the first exemplary embodiment at the required angle with reference to the intersection P1 between the attaching surface 56e and the virtual line L2 (or L1).

In the supporting structure 6B that supports the follower roller 362 illustrated in FIG. 9A, a corner 57b at the one end of the pressing member 57 is first in contact with the attaching surface 56f of the bearing member 56B at the point P2 that is on the downstream side in the rotating direction C of the follower roller 362 with respect to the intersection P1. Therefore, the pressing force F generated by the pressing member 57 starts to act on a point (the point P2, actually) of the attaching surface 56f of the bearing member 56B that is on the downstream side in the rotating direction C of the follower roller 362 with respect to the intersection P1.

That is, in the supporting structure 6B, the attaching surface 56f of the bearing member 56B first receives the pressing force F from the pressing member 57 at the point P2 that is displaced from the intersection P1. Therefore, regardless of whether or not the follower roller 362 is rotated, the bearing member 56B rotates about the rotating shaft 52, as illustrated in FIG. 9B, in the same direction as the rotating direction C of the rotating shaft 52 (the follower roller 362) inside (the movable space enclosed by) the movable attaching portion 71B of the supporting member 70, whereby the bearing member 56B as a whole is tilted.

In the supporting structure 6B, when the follower roller 362 is rotated, as illustrated in FIG. 9B, not only the rotational force Mr generated by the frictional force between the bearing member 56B and the rotating shaft 52 of the follower roller 362 and that causes the bearing member 56B to rotate in the rotating direction C but also a second rotational force Md described below is generated.

Specifically, in the supporting structure 6B, as illustrated in FIG. 9B, the pressing member 57 is in contact with a portion of the tilted attaching surface 56f of the bearing member 56B. Therefore, the pressing force F generated by the pressing member 57 contains a component force fd acting in a direction similar to the rotating direction C of the rotating shaft 52, and the component force fd acts on the bearing member 56B as the second rotational force Md that causes the bearing member 56B to rotate in the rotating direction C.

That is, in the supporting structure 6B, the bearing member 56B receives two rotational forces Mr and Md. Therefore, the bearing member 56B is retained at a position determined after being rotated in the same direction as the rotating direction C of the rotating shaft 52 inside (the movable space enclosed by) the movable attaching portion 71B of the supporting member 70.

Consequently, as substantially in the same manner as the case of the supporting structure 6A according to the first exemplary embodiment, the supporting structure 6B does not make the repeated movement that tends to occur in the comparative supporting structure 60 (illustrated in FIGS. 15, 16A, and 16B) in which the bearing member 56B rotates in the direction opposite to or the same as the rotating direction C of the rotating shaft 52 and then returns to the initial normal position or further rotates beyond the normal position inside the movable space enclosed by the movable attaching portion 71B. Consequently, the occurrence of noise and vibrations attributed to the above repeated movement is suppressed.

Furthermore, in the supporting structure 6B, there is no need to displace the center 57a of the pressing member 57 from the intersection P1, unlike the case of the pressing member 57 of the supporting structure 6A according to the first exemplary embodiment. Instead, the shape of an end face of the bearing member 56 that is to be in contact with the pressing member 57 is changed, whereby the above effects are produced.

Since the occurrence of noise and vibrations that may occur in the comparative supporting structure 60 is suppressed in the supporting structure 6B, the recording sheet 9 is transported in a good manner without the occurrence of noise and vibrations in the pair of first discharge rollers 36 and in the transport device 7 including the same in substantially the same manner as in the case of the supporting structure 6A according to the first exemplary embodiment.

In addition, the supporting structure GB has other functions and produces corresponding effects that are substantially the same as those described above for the supporting structure 6A according to the first exemplary embodiment.

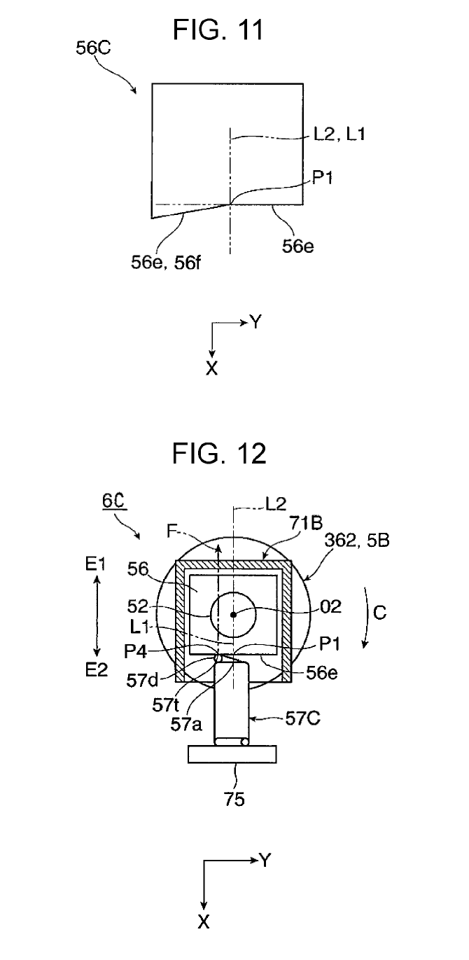

The bearing member 56B of the supporting structure 6B may be replaced with, for example, a bearing member 56C shaped as illustrated in FIG. 11.

An attaching surface of the bearing member 56C illustrated in FIG. 11 that is to be in contact with the pressing member 57 includes a tilted portion as the attaching surface 56f only on the downstream side in the rotating direction C of the follower roller 362 with respect to the intersection P1 between the attaching surface and the virtual line L2 (or L1), and a substantially horizontal portion as the attaching surface 56e on the upstream side in the rotating direction C. The horizontal substantially portion is the same as the attaching surface 56e of the bearing member 56 according to the first exemplary embodiment.

The supporting structure 6B including the bearing member 56C has functions and produces corresponding effects that are substantially the same as those described above.

### Third Exemplary Embodiment

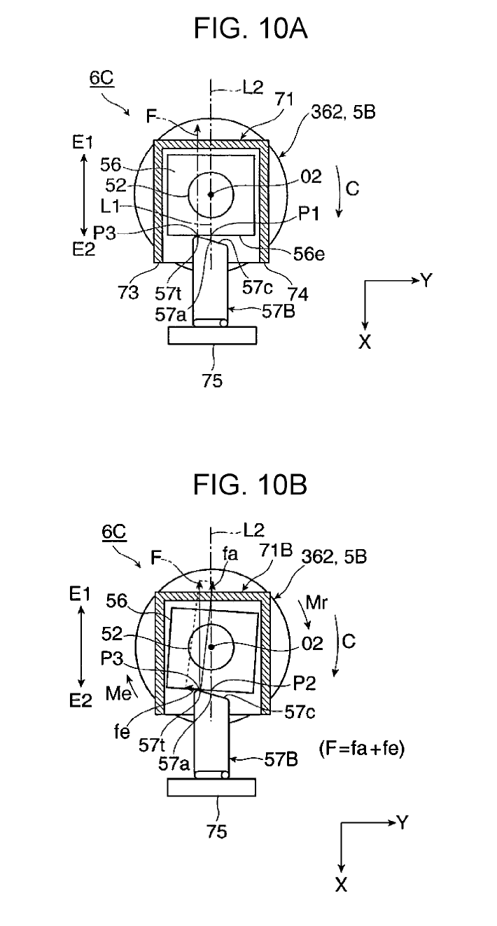

FIGS. 10A and 10B illustrate a supporting structure 6C according to a third exemplary embodiment that supports the follower roller 362.

The supporting structure 6C has the same configuration as the supporting structure 6A or 6B according to the first or second exemplary embodiment, except that an end of the pressing member 57 is shaped in such a manner as to be first in contact with a portion of the attaching surface 56e of the bearing member 56 that is on the downstream side in the rotating direction C of the follower roller 362 with respect to the intersection P1 between the attaching surface 56e and the virtual line L2 (or L1). Therefore, in FIGS. 10A and 10B, elements that are the same as those of the supporting structure 6A or 6B are denoted by corresponding ones of the reference numerals and characters used in the first or second exemplary embodiment.

As illustrated in FIG. 10A, the supporting structure 6C according to the third exemplary embodiment includes, instead of the pressing member 57, a pressing member 57B having a tilted end face 57c to be in contact with the bearing member 56. The end face 57c is generally continuously tilted at a required angle such that a downstream portion thereof in the rotating direction C of the follower roller 362 is closer to the bearing member 56 than an upstream portion thereof.

The end face 57c of the pressing member 57B forms a surface tilted at the above required angle with reference to the center 57a thereof (the intersection between the end face 57c and the virtual line L2 (or L1)). The pressing member 57 having such a tilted end face 57c may be obtained by, for example, cutting an end of a compression coil spring to be employed as the pressing member 57B.

In the supporting structure 6C illustrated in FIG. 10A that supports the follower roller 362, an apex 57t at the end face 57c of the pressing member 57B is first in contact with the attaching surface 56e of the bearing member 56 at a point P3 that is on the downstream side in the rotating direction C of the follower roller 362 with respect to the intersection P1. Therefore, the pressing force F generated by the pressing member 57B starts to act on a point (the point P3, actually) of the attaching surface 56e of the bearing member 56 that is on the downstream side in the rotating direction C of the follower roller 362 with respect to the intersection P1.

In the supporting structure 6C, the attaching surface 56e of the bearing member 56 first receives the pressing force F from the apex 57t of the pressing member 57B at the point P3 that is displaced from the intersection P1. Therefore, regardless of whether or not the follower roller 362 is rotated, the bearing member 56 rotates about the rotating shaft 52, as illustrated in FIG. 10B, in the same direction as the rotating direction C of the rotating shaft 52 (the follower roller 362) inside (the movable space enclosed by) the movable attaching portion 71B of the supporting member 70, whereby the bearing member 56 as a whole is tilted.

In the supporting structure 6C, when the follower roller 362 is rotated as illustrated in FIG. 10B, not only the rotational force Mr generated by the frictional force between the bearing member 56 and the rotating shaft 52 of the follower roller 362 and that causes the bearing member 56 to rotate in the rotating direction C but also a second rotational force Me described below is generated.

Specifically, in the supporting structure 6C, as illustrated in FIG. 10B, the apex 57t at the tilted end face 57c of the pressing member 57B is in contact with a point (the point P3) of the attaching surface 56e of the bearing member 56 that is tilted. Therefore, the pressing force F generated by the pressing member 57B contains a component force fe acting in a direction similar to the rotating direction C of the rotating shaft 52, and the component force fe acts on the bearing member 56 as the second rotational force Me that causes the bearing member 56 to rotate in the rotating direction C.

That is, in the supporting structure 6C, the bearing member 56 receives two rotational forces Mr and Me. Therefore, the bearing member 56 is retained at a position determined after being rotated in the same direction as the rotating direction C of the rotating shaft 52 within (the movable space enclosed by) the movable attaching portion 71B of the supporting member 70.

Consequently, as substantially in the same manner as the case of the supporting structure 6A or 6B according to the first or second exemplary embodiment, the supporting structure 6C does not make the repeated movement that tends to occur in the comparative supporting structure 60 (illustrated in FIGS. 15, 16A, and 16B) in which the bearing member 56 rotates in the direction opposite to or the same as the rotating direction C of the rotating shaft 52 and then returns to the initial normal position or further rotates beyond the normal position inside the movable space enclosed by the movable attaching portion 71B. Consequently, the occurrence of noise and vibrations attributed to the above repeated movement is suppressed.

Furthermore, in the supporting structure 6C, there is no need to displace the center 57a of the pressing member 57B from the intersection P1, unlike the case of the pressing member 57 of the supporting structure 6A according to the first exemplary embodiment. Instead, the shape of the end face of the pressing member 57B that is in contact with the bearing member 56 is changed, whereby the above effects are produced.

Since the occurrence of noise and vibrations that may occur in the comparative supporting structure 60 is suppressed in the supporting structure 6C, the recording sheet 9 is transported in a good manner without the occurrence of noise and vibrations in the pair of first discharge rollers 36 and in the transport device 7 including the same in substantially the same manner as in the case of the supporting structure 6A according to the first exemplary embodiment.

In addition, the supporting structure 6C has other functions and produces corresponding effects that are substantially the same as those described above for the supporting structure 6A according to the first exemplary embodiment.

The pressing member 57B of the supporting structure 6C may be replaced with, for example, a pressing member 57C shaped as illustrated in FIG. 12.

The pressing member 57C illustrated in FIG. 12 is a pressing member (compression coil spring) whose end face (the end face of the spring wire) 57d to be in contact with the bearing member 56 is processed such that a portion on the downstream side in the rotating direction C of the follower roller 362 projects and is closer to the bearing member 56 than a portion on the upstream side.

The supporting structure 6C including the pressing member 57C has functions and produces corresponding effects that are substantially the same as those described above.

In the supporting structure 6C including the pressing member 57C illustrated in FIG. 12, the apex 57t at the end face 57d thereof (the end face of the spring wire) is first in contact with the attaching surface 56e of the bearing member 56 at a point P4 that is on the downstream side in the rotating direction C of the follower roller 362 with respect to the intersection P1. Therefore, the pressing force F generated by the pressing member 57C starts to act on a point (the point P4, actually) of the attaching surface 56e of the bearing member 56 that is on the downstream side in the rotating direction C of the follower roller 362 with respect to the intersection P1.

### Fourth Exemplary Embodiment

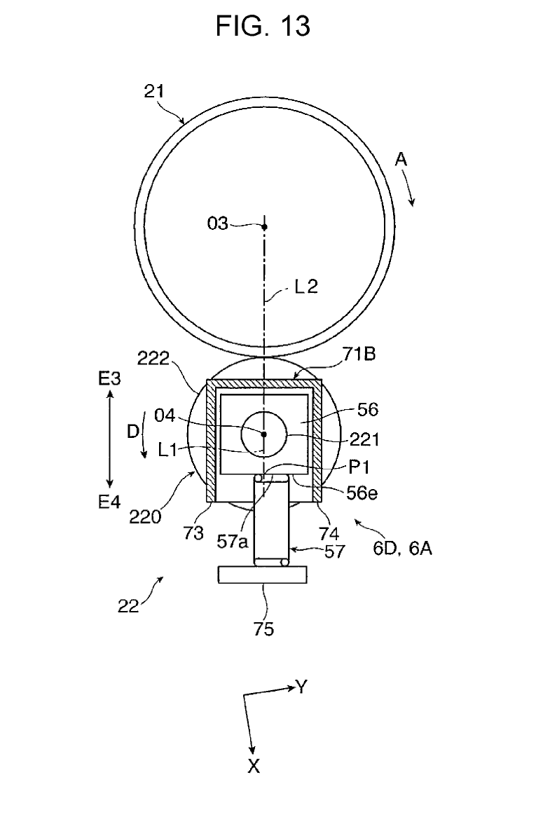

FIG. 13 illustrates a supporting structure 6D according to a fourth exemplary embodiment that supports a charging roller 220, and the charging device 22 including the same.

The supporting structure 6D supports the charging roller 220 included in the charging device 22 of the imaging device 2 and is an application of, for example, the supporting structure 6A (illustrated in FIGS. 6 and 7A) according to the first exemplary embodiment.

The charging roller 220 is a rotatable member including, for example, a rotating shaft 221 to which a charging voltage is supplied, and a roller portion 222 provided around the rotating shaft 221 and having a multi-layer structure including an elastic layer, a surface layer, and so forth. The charging roller 220 rotates by being in contact with the peripheral surface of the photoconductor drum 21 that is driven to rotate in the direction of arrow A, thereby charging the peripheral surface of the photoconductor drum 21.

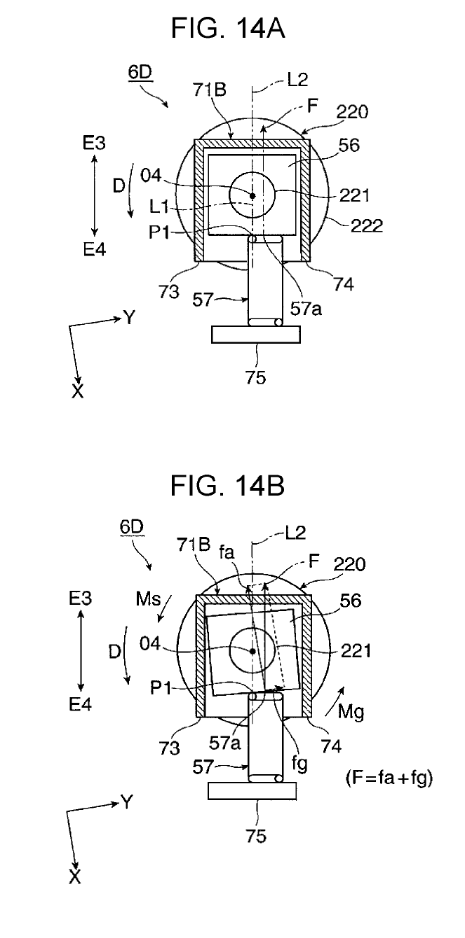

As illustrated in FIGS. 13 and 14A, the charging roller 220 is used together with the photoconductor drum 21 that is driven to rotate while being in contact with the charging roller 220. The charging roller 220 is supported by the supporting structure 6D, which includes a bearing member 56 by which the rotating shaft 221 as a shaft portion is rotatably supported, a pressing member 57 that presses the bearing member 56 in a direction E3 toward the photoconductor drum 21, and (an attaching portion 71B of) a supporting member 70 by which the bearing member 56 is supported in such a manner as to be retractably movable in the direction E3 in which the pressing member 57 presses the bearing member 56. The pressing member 57 presses the bearing member 56 in the direction E3.

As substantially in the same manner as the case of the supporting structure 6A according to the first exemplary embodiment, the supporting structure 6D according to the fourth exemplary embodiment is configured such that, as illustrated in FIGS. 13 and 14A, a pressing force F generated by the pressing member 57 is greatest at a point of (an attaching surface 56e of) the bearing member 56 that is on the downstream side in a rotating direction D of the charging roller 220 with respect to an intersection P1 between the attaching surface 56e and a virtual line L2 connecting a rotation center 04 of the charging roller 220 and a rotation center 03 of the photoconductor drum 21.

In the supporting structure 6D that supports the charging roller 220, as illustrated in FIG. 14A, the pressing force F generated by the pressing member 57 is greatest at the point of the attaching surface 56e of the bearing member 56 that is on the downstream side in the rotating direction D of the charging roller 220 with respect to the intersection P1 between the attaching surface 56e and the virtual line L2 (or L1).

An end face of the pressing member 57 that is in contact with the attaching surface 56e of the bearing member 56 has a substantially flat annular shape. Therefore, the above pressing force F is centered on the center 57a of the end face of the pressing member 57.

In the supporting structure 6D, the attaching surface 56e of the bearing member 56 receives the greatest pressing force F from the pressing member 57 at a point that is displaced from the intersection P1. Therefore, regardless of whether or not the charging roller 220 is rotated, the bearing member 56 rotates about the rotating shaft 221, as illustrated in FIG. 14, in the same direction as the rotating direction D of the rotating shaft 221 (the charging roller 220) inside (the movable space enclosed by) the movable attaching portion 71B of the supporting members 70. That is, the bearing member 56 as a whole is tilted.

In the supporting structure 6D, when the charging roller 220 is rotated in the rotating direction D by following the rotation of the photoconductor drum 21 as illustrated in FIG. 14B, not only the rotational force Ms generated by the frictional force between the bearing member 56 and the rotating shaft 221 of the charging roller 220 and that causes the bearing member 56 to rotate in the rotating direction D but also a second rotational force Mg described below is generated.

Specifically, in the supporting structure 6D, as illustrated in FIG. 14B, the pressing member 57 is in contact with the tilted attaching surface 56e of the bearing member 56. Therefore, the pressing force F generated by the pressing member 57 contains a component force fg acting in a direction similar to the rotating direction D of the rotating shaft 221, and the component force fg acts on the bearing member 56 as the second rotational force Mg that causes the bearing member 56 to rotate in the rotating direction D.

That is, in the supporting structure 6D, the bearing member 56 receives two rotational forces Ms and Mg. Therefore, the bearing member 56 is retained at a position determined after being rotated in the same direction as the rotating direction D of the rotating shaft 221 (the charging roller 220) inside (the movable space enclosed by) the movable attaching portion 71B of the supporting member 70.

Consequently, the supporting structure 6D does not make the repeated movement that tends to occur in the comparative supporting structure 60 (illustrated in FIGS. 15, 16A, and 16B) in which the bearing member 56 rotates in the direction opposite to or the same as the rotating direction C of the rotating shaft 52 and then returns to the initial normal position or further rotates beyond the normal position. Consequently, the occurrence of noise and vibrations attributed to the above repeated movement is suppressed.

In the charging device 22 employing the supporting structure 6D, since the occurrence of vibrations that may occur in the comparative supporting structure 60 is suppressed, the occurrence of charging nonuniformity attributed to the vibrations is suppressed. Consequently, the peripheral surface of the photoconductor drum 21 is charged in a good manner.

In addition, the supporting structure 6D has other functions and produces corresponding effects that are substantially the same as those described above, even if the bearing member 56 is of a type that bears the rotating shaft 221 while allowing the sliding and rotation of the rotating shaft 221 thereon.

### Other Exemplary Embodiments

The first to third exemplary embodiments concern the supporting structures 6A to 6C that each support the follower roller 362 (the rotatable member 5B) included in the pair of first discharge rollers 36. The present invention is also applicable to the driving roller 361 (the rotatable member 5A) included in the pair of first discharge rollers 36.

The pair of first discharge rollers 36 may have only a function of transporting the recording sheet 9, without the function as the decurling mechanism.

The supporting structures 6A to 6C according to the first to third exemplary embodiment may each be applied to a supporting structure that supports at least one of another pair of transport rollers (rotatable members) of a transport device that are rotatable while being pressed against each other and are configured to transport the recording sheet 9 by nipping the recording sheet 9 therebetween.

The application of each of the supporting structures 6A to 6C according to the first to third exemplary embodiments is not limited to the supporting structure 6D that supports the charging roller 220 of the charging device 22 included in the imaging device 2 described in the fourth exemplary embodiment and may be another rotatable-member-supporting structure. Examples of another rotatable member include a transfer roller, a fixing roller, and so forth.

The supporting structures 6A to 6C are each also applicable to a supporting structure that supports a pressing roller to be pressed against a portion of an endless belt that is not supported by a supporting roller. In such a case, the rotatable member to be in contact with the pressing roller is the portion of the rotating belt that is not supported by the supporting roller.

The image forming apparatus including the rotatable member and the transport device employing any of the supporting structures 6A to 6C is not limited to an apparatus that forms a monochrome image composed of toner having a single color as described in the first to fourth exemplary embodiment, and may be an image forming apparatus of another type.

Examples of the image forming apparatus of another type include an image forming apparatus that forms a multi-color image composed of toners having different colors, an image forming apparatus that forms an image by ejecting ink droplets, and so forth.

The rotatable member and the transport device employing any of the supporting structures 6A to 6C may be a rotatable member and a transport device included in any apparatus other than the image forming apparatus.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A rotatable-member-supporting structure comprising:
a first rotatable member having a shaft portion;
a bearing member by which the shaft portion of the first rotatable member is rotatably supported;
a pressing member that presses the bearing member in one direction; and
a supporting member by which the bearing member is supported in such a manner as to be retractably movable in the direction in which the pressing member presses the bearing member,
wherein a pressing force generated by the pressing member is greatest in a portion of the bearing member that is on a downstream side in a direction of rotation of the first rotatable member with respect to an intersection between the bearing member and a first virtual line extending from a center of rotation of the first rotatable member toward the pressing member in the direction in which the supporting member is retractably movable.

2. A rotatable-member-supporting structure comprising:
a first rotatable member having a shaft portion;
a second rotatable member having a shaft portion and that rotates by being in contact with the first rotatable member;
a bearing member by which the shaft portion of the first rotatable member is rotatably supported;
a pressing member that presses the bearing member in a direction toward the second rotatable member; and
a supporting member by which the bearing member is supported in such a manner as to be retractably movable in the direction in which the pressing member presses the bearing member,
wherein a pressing force generated by the pressing member is greatest in a portion of the bearing member that is on a downstream side in a direction of rotation of the first rotatable member with respect to an intersection between the bearing member and a second virtual line connecting a center of rotation of the first rotatable member and a center of rotation of the second rotatable member.

3. The rotatable-member-supporting structure according to claim 1, wherein the pressing member is in contact with the bearing member at a position that is displaced toward the downstream side in the direction of rotation of the first rotatable member from the intersection between the bearing member and the first virtual line.

4. The rotatable-member-supporting structure according to claim 2, wherein the pressing member is in contact with the bearing member at a position that is displaced toward the downstream side in the direction of rotation of the first rotatable member from the intersection between the bearing member and the second virtual line.

5. The rotatable-member-supporting structure according to claim 3, wherein the pressing member is in contact with the bearing member such that the pressing member overlaps the intersection between the bearing member and the first virtual line while a center of the pressing member is displaced from the intersection.

6. The rotatable-member-supporting structure according to claim 4, wherein the pressing member is in contact with the bearing member such that the pressing member overlaps the intersection between the bearing member and the second virtual line while a center of the pressing member is displaced from the intersection.

7. The rotatable-member-supporting structure according to claim 1, wherein the pressing force generated by the pressing member starts to act on a portion of the bearing member that is on the downstream side in the direction of rotation of the first rotatable member with respect to the intersection between the bearing member and the first virtual line.

8. The rotatable-member-supporting structure according to claim 2, wherein the pressing force generated by the pressing member starts to act on a portion of the bearing member that is on the downstream side in the direction of rotation of the first rotatable member with respect to the intersection between the bearing member and the second virtual line.

9. The rotatable-member-supporting structure according to claim 7, wherein a surface of the bearing member that is in contact with the pressing member is shaped such that the surface is first in contact with the pressing member at a position that is on the downstream side in the direction of rotation of the first rotatable member with respect to the intersection between the bearing member and the first virtual line.

10. The rotatable-member-supporting structure according to claim 8, wherein a surface of the bearing member that is in contact with the pressing member is shaped such that the surface is first in contact with the pressing member at a position that is on the downstream side in the direction of rotation of the first rotatable member with respect to the intersection between the bearing member and the second virtual line.

11. The rotatable-member-supporting structure according to claim 7, wherein an end of the pressing member that is in contact with the bearing member is shaped such that the end is first in contact with a surface of the bearing member at a position that is on the downstream side in the direction of rotation of the first rotatable member with respect to the intersection between the bearing member and the first virtual line.

12. The rotatable-member-supporting structure according to claim 8, wherein an end of the pressing member that is in contact with the bearing member is shaped such that the end is first in contact with a surface of the bearing member at a position that is on the downstream side in the direction of rotation of the first rotatable member with respect to the intersection between the bearing member and the second virtual line.

13. An image forming apparatus comprising the rotatable-member-supporting structure according to claim 1.
